(19) United States
(12) Patent Application Publication
(10) Pub. No.: US 2026/0229131 A1
(43) Pub. Date: Aug. 6, 2026

(54) TRAFFIC MANAGEMENT DEVICE AND TRAFFIC MANAGEMENT SYSTEM

(71) Applicant: Hitachi, Ltd., Tokyo (JP)

(72) Inventors: Taku SHIMIZU, Tokyo (JP); Takahiro ITO, Tokyo (JP)

(21) Appl. No.: 19/463,967

(22) Filed: Jan. 29, 2026

(30) Foreign Application Priority Data
Feb. 6, 2025 (JP) 2025-018352

(51) Int. Cl. G08G 5/34; G08G 5/265; G08G 5/57; G08G 5/59; G08G 5/76

(52) U.S. Cl. CPC G08G 5/34; G08G 5/265; G08G 5/57; G08G 5/59; G08G 5/76

(57) ABSTRACT

In a traffic management device that creates a movement plan of a mobile object and includes a processor and a storage device, the processor classifies a space into three areas including a movable area, an unmovable area, and an unclear area, based on environment information about the space related to the movement plan, creates a first movement plan of the mobile object from a departure spot to a first destination in the space, and creates a second movement plan passing through only the movable area as a movement plan of the mobile object from the departure spot to a second destination different from the first destination or the first destination upon creating a plan passing through the unclear area as the first movement plan.

### CROSS-REFERENCE TO RELATED APPLICATION

The present application claims priority from Japanese application JP2025-018352, filed on February 6, 2025, the content of which is hereby incorporated by reference into this application.

### BACKGROUND OF THE INVENTION

### 1. Field of the Invention

The present invention relates to a traffic management device and a traffic management system capable of creating a movement plan of a mobile object.

### 2. Description of the Related Art

There is a demand for highly efficient traffic management (control) of various mobile objects (mobilities) including electric vertical takeoff and landing machines (eVTOL, drone, etc.) called air mobilities. The mobile objects include a flying object, and further include any means related to movement and transportation, such as general automobiles such as a private automobile, a bus, a taxi, and a truck, two-wheeled vehicles such as a motorcycle, a bicycle, and a motor-assisted bicycle, a railway, and a mobility scooter.

For example, JP 2019-32661 A discloses that regarding an air traffic control device for an uncrewed aerial vehicle, a control area is divided into a plurality of areas, a determination is made, for each of the areas, whether the uncrewed aerial vehicle can fly, and a flight path of the uncrewed aerial vehicle is designed so as to pass through the determined flyable area.

### SUMMARY OF THE INVENTION

The air traffic control device in JP 2019-32661 A refers to weather information that can change with time when the device determines whether an aircraft can fly in each area. However, the accuracy and resolution of weather prediction based on the weather information have to be deteriorated as the time of prediction comes earlier. Therefore, an area determined to be an unflyable area based on the weather information at the time of planning the moving path (flight path) may be determined to be a flyable area based on weather information at the time of actual flight and vice versa. For example, if a determination is made whether a flight can be carried out with the weather information taken into consideration pessimistically, a detour or cancellation of a flight is forced. As a result, the flight efficiency and the flight frequency are more likely to be degraded. Conversely, if a determination is made with the weather information taken into consideration optimistically, the flight is more likely to be incapable of being carried out at the time of actual flight on a path based on the determination. That is, when a moving path is determined based on weather information at the time of planning, there is a limit in selecting a highly efficient moving path. This type of problem is related not only with weather information (for example, a precipitation or snowfall amount, a precipitation or snowfall percentage, a wind direction, a wind speed, a wave height, a water level of a river, and volcanic information) but also with data that can change with time (for example, environment information such as a data communication state) in accordance with the environment in which a mobile object moves.

An object of the present invention is to provide a traffic management device capable of selecting a more preferable movement plan while securing feasibility at a time of actual movement of a mobile object.

An aspect of the present invention provides a traffic management device that creates a movement plan of a mobile object including a processor and a storage device, wherein the processor classifies a space into three areas including a movable area where the mobile object is movable, an unmovable area where the mobile object is unmovable, and an unclear area where it is unclear whether the mobile object is movable, based on environment information about the space related to the movement plan stored in the storage device, creates a first movement plan of the mobile object from a departure spot to a first destination in the space, creates a second movement plan passing through only the movable area as a movement plan of the mobile object from the departure spot to a second destination different from the first destination or the first destination upon creating a plan passing through the unclear area as the first movement plan, and outputs the first movement plan and the second movement plan.

According to the present invention, in a case where the first movement plan having an uncertain feasibility is created at the time of planning, the second movement plan having a higher feasibility is also created in addition to the first movement plan. Therefore, a more preferable movement plan can be selected at the time of actual movement while the feasibility is being maintained.

### BRIEF DESCRIPTION OF THE DRAWINGS

FIG. 1 is a schematic configuration diagram of a traffic management system according to an embodiment of the present invention;

FIG. 2 is a flowchart of movement plan creation executed by a processor of a traffic management device according to a first embodiment;

FIG. 3 is a diagram illustrating an example of a first movement plan of a mobile object including a first moving path;

FIG. 4 is a diagram illustrating an example of a second movement plan of the mobile object including a second moving path;

FIG. 5 is an explanatory diagram in a case where a destination of the second movement plan is a departure spot (second destination);

FIG. 6 is an explanatory diagram in a case where the destination of the second movement plan is an emergency destination;

FIG. 7 is a diagram illustrating an example of a first movement plan in a second embodiment;

FIG. 8 is a diagram illustrating an example of a second movement plan corresponding to a first movement plan of FIG. 7;

FIG. 9 is a flowchart of movement plan creation executed by the processor of the traffic management device according to the second embodiment;

FIG. 10 is an explanatory diagram of an area (update target area) where new environment information is to be acquired and read in a fourth embodiment;

FIG. 11 is a flowchart of movement plan creation executed by the processor of the traffic management device according to a fifth embodiment; and

FIG. 12 is an explanatory diagram of changes in the first and second movement plans according to the fifth embodiment.

### DESCRIPTION OF THE PREFERRED EMBODIMENTS

Embodiments of the present invention will be described below with reference to the drawings.

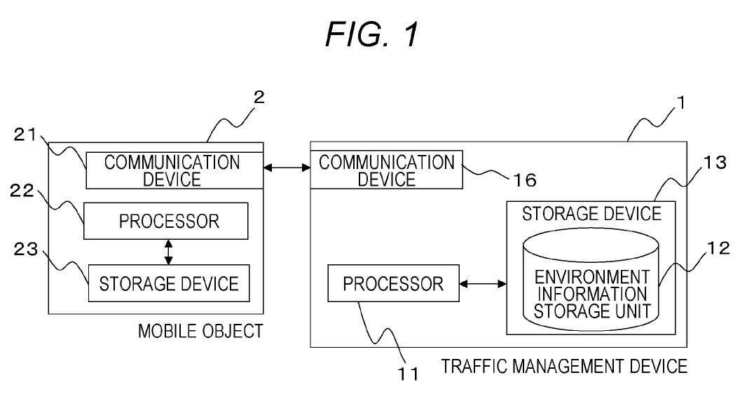

FIG. 1 is a schematic configuration diagram of a traffic management system according to embodiments of the present invention. The traffic management system in this drawing includes a traffic management device 1 and at least one mobile object 2. The traffic management device 1 and each mobile object 2 are wirelessly connected so as to be able to perform bidirectional data communication. In order to simplify the description, FIG. 1 illustrates only one mobile object 2.

The traffic management device 1 is, for example, a computer, and includes a processor 11, a storage device 13 such as a memory that stores programs executed by the processor 11 and data, and a communication device 16 for performing data communication with an external terminal including the mobile object 2. The traffic management device 1 may be connected with input devices such as a keyboard, a mouse, and a touch panel operated by an operator, an output device such as a display, and the like.

In the storage device 13 of the traffic management device 1, an environment information storage unit 12 is secured as an area in which environment information that is data related to a moving space of the mobile object 2 is stored. The environment information includes weather information (for example, a precipitation or snowfall amount, a precipitation or snowfall percentage, a wind direction, a wind speed, a wave height, a water level of a river, and volcanic information) and its prediction information (predicted weather information), geographical information (map data, terrain data, building data, structure data, data communication state data, etc.), and the like. Further, the storage device 13 stores specification data (for example, a weight, a maximum moving speed, a limit altitude, a maximum moving time, an operating environmental temperature, a maximum wind pressure resistance, a battery capacity, and a battery voltage) of each mobile object 2 for preparing a movement plan. Further, data (a moving speed, an attitude, a position, a remaining battery amount, etc.) regarding a moving state of each mobile object 2 under management is transmitted from each mobile object 2 and is sequentially stored in the storage device 13.

The mobile object 2 is, for example, a drone, and includes a processor 22, a storage device 23 such as a memory that stores programs executed by the processor 22 and data, and a communication device 21 for performing data communication with an external terminal including the traffic management device 1. The mobile object 2 is mounted with a propeller that generates propulsion and a prime motor that rotationally drives wheels. The prime motor can be controlled based on a signal calculated by the processor 22. The mobile object 2 may be equipped with an inertial measurement device for measuring the attitude of the mobile object 2, a global navigation satellite system (GNSS) antenna for measuring the position of a self-device, a receiver, and the like. The mobile object 2 may autonomously operate (automatically operate) in accordance with a movement plan including a moving path stored in the storage device 23. Further, an operation signal of an operation device operated by an operator may be received via the communication device 21, and operation (manual driving) may be performed based on the operation signal.

The traffic management device 1 creates a movement plan of at least one mobile object 2 under management based on information (environment information) regarding a moving space of the mobile object 2 and specification information regarding the mobile object 2. The movement plan includes a moving path of the mobile object 2. A departure spot, a relay spot, and a destination are defined for the moving path, and a path from the departure spot to the destination via the relay spot is the moving path. Note that the relay spot may be omitted from the moving path. First, geographical information about the moving space is used to create the moving path. That is, a path on which the mobile object 2 can physically move is selected from paths connecting the departure spot and the destination based on the geographical information. From the viewpoint of improving efficiency, a moving path with a short distance is preferably selected from a plurality of moving paths created from the geographical information. Secondly, predicted weather information at the time of movement of the mobile object 2 is used. That is, the moving path is selected by adding the predicted weather information to the moving path selected based on the geographical information. As for the predicted weather information, weather information at the time of movement may be predicted from current weather information, or predicted weather information acquired from a weather prediction service may be used. For example, in the predicted weather information, an area where the precipitation percentage is greater than or equal to a predetermined value, an area where the precipitation amount is greater than or equal to a predetermined value, an area where the wind speed is greater than or equal to a predetermined value, and the like are determined to be difficult for the mobile object 2 to move and are excluded from the moving path. The moving path may be corrected so as to detour these areas.

In the present embodiment, the traffic management device 1 can classify the moving space into three types of areas based on the moving space environment information stored in the storage device 13. The three types of areas include (1) a movable area where the mobile object 2 is movable, (2) an unmovable area where the mobile object 2 is unmovable, and (3) an unclear area where it is unclear whether the mobile object 2 is movable (in other words, an area where a determination cannot be made whether the mobile object 2 is movable). Note that the movable area may be further classified into any of two areas including a geographical movable area and a meteorological movable area in accordance with a factor for determining that the mobile object 2 is movable. Similarly, the unmovable area may be classified into a geographically unmovable area and a meteorological unmovable area, or the unclear area may be classified into a geographically unclear area and a meteorological unclear area. When the moving space is classified into three types of areas, the moving space may be divided into a plurality of areas (sometimes referred to as divided areas), and the type of each divided area may be classified into one of the above three types based on the environment information about each divided area. The divided area may be, for example, an area obtained by dividing the moving space into a predetermined shape (for example, a lattice shape). As the predicted weather information about each divided area, predicted weather information having the worst prediction among the predicted weather information included in each of the divided areas may be used, or prediction obtained by averaging the predictions in the divided areas may be used.

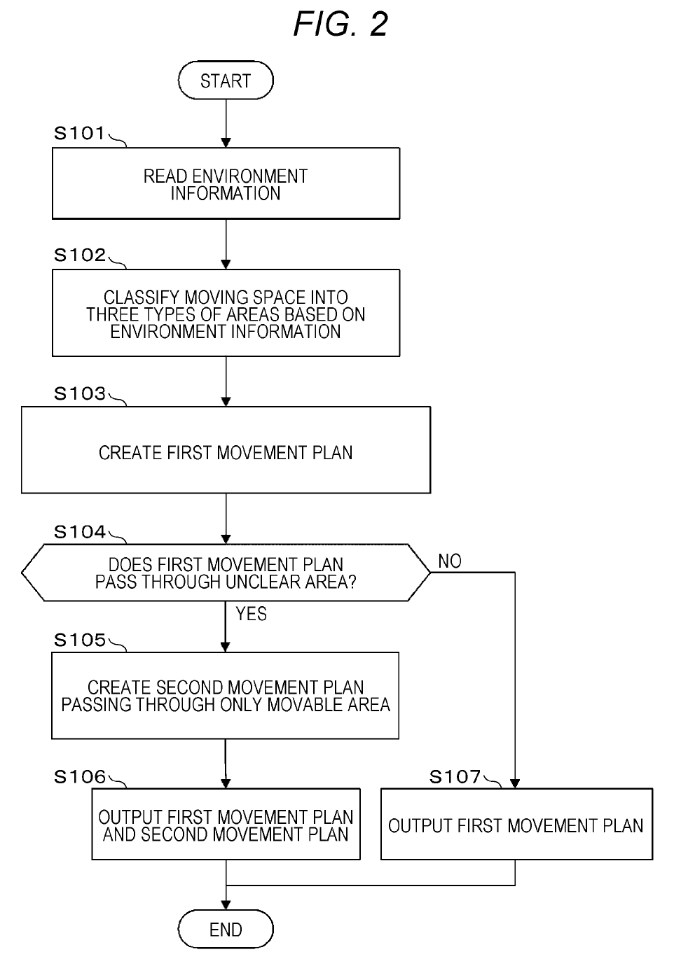

FIG. 2 is a flowchart of movement plan creation executed by the processor 11 of the traffic management device 1 according to a first embodiment. The traffic management device 1 acquires the environment information about the space (moving space) related to the movement plan of the mobile object 2 from the outside and stores the environment information in the storage device 13 (environment information storage unit 12) in advance. Further, the moving space of the mobile object 2 is assumed to be divided into a plurality of divided areas.

When a traffic plan start instruction is input from an operator in creating the traffic plan of the mobile object 2, the traffic management device 1 starts the flow of FIG. 2, reads the environment information from the storage device 13 (S101), and classifies the moving space into three types of areas including the movable area, the unmovable area, and the unclear area based on the environment information (S102).

The traffic management device 1 creates a movement plan (first movement plan) of the mobile object 2 based on a result of classifying the moving space into the three types of divided areas in S102 and data of a departure spot (departure point) and a destination (destination point) of the mobile object 2 (S103). The first movement plan includes a moving path (first moving path) along which the mobile object 2 moves from the departure spot to the destination, and a relationship between the position of the mobile object 2 on the moving path and the elapsed time from the departure time (that is, a plan indicating what time and where the mobile object 2 should be located). The traffic management device 1 reads the data of the departure spot (departure point) and the destination (destination point) of the mobile object 2, and selects the first moving path between the departure spot and the destination. However, the area where the first moving path is selected excludes the unmovable area, and is selected from the movable area and the unclear area.

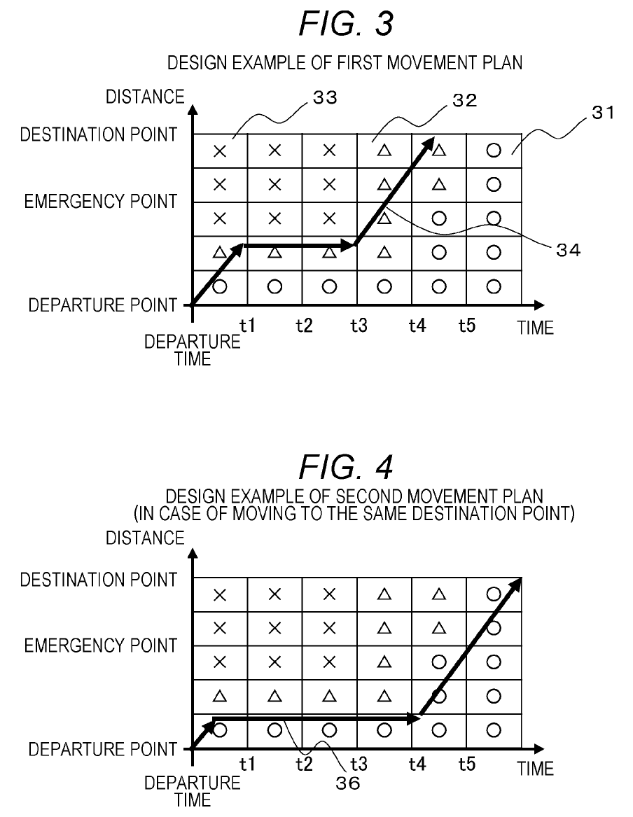

FIG. 3 is a diagram illustrating an example of a first movement plan 34 of the mobile object 2 including the first moving path. In this drawing, a horizontal axis represents the elapsed time from a departure time, and a vertical axis represents the distance (position) from the departure point. In the example of the drawing, it is assumed that one moving path is fixed. Further, one cell among the cells defined in the drawing indicates one divided area. The number of cells arranged in the vertical axis direction (distance direction) indicates the number of divided areas through which the mobile object 2 passes from the departure spot to the destination, and in the example of the drawing, the mobile object 2 passes five divided areas from the departure spot to the destination. Depending on weather conditions or the like, the type of each divided area may change as time passes. A circle graphic in the drawing indicates that the divided area is a movable area 31 at the time, a triangle graphic indicates an unclear area 32, and a cross mark indicates an unmovable area 33. The first movement plan 34 in FIG. 3 is a plan from a departure spot in the movable area 31 to a destination via the unclear area 32. A straight line 34 in the drawing indicates the first movement plan. The mobile object 2 waits in the unclear area 32 because the unmovable area 33 is generated on the moving path between time t1 and time t3. The mobile object 2 is planned to travel again toward the destination after time t3 at which the unmovable area 33 disappears on the rest of the path.

In S104, the traffic management device 1 determines whether the first movement plan created in S103 passes through the unclear area 32. When the first movement plan does not pass through the unclear area 32, that is, when the first movement plan passes through only the movable area 31, only the first movement plan is output (S107), and the processing of the flowchart is ended. Examples of the output destination of the first movement plan include the mobile object 2, a terminal installed in a control center, and a terminal of the operator of the mobile object 2.

On the other hand, when the first movement plan created in S103 passes through the unclear area 32 (for example, in a case where the first movement plan 34 as illustrated in FIG. 3 is created), the traffic management device 1 creates a second movement plan 36 passing through only the movable area 31 (S105).

FIG. 4 is a diagram illustrating an example of the second movement plan 36 of the mobile object 2 including a second moving path. The first movement plan and the moving path in FIG. 3 are the same as those in FIG. 4, and the departure time and the destination are also the same as those in FIG. 4. Since the second divided area on the moving path is the unclear area 32 during a period from the departure time to time t4, in the second movement plan 36, the mobile object 2 waits in the first divided area shortly after the departure, and then advances toward the destination again after time t4 when the second and subsequent divided areas become movable areas. The destination arrival time is later than that of the first movement plan 34.

After creating the second movement plan in S105, the traffic management device 1 outputs the first movement plan and the second movement plan (S106), and ends the processing of the flowchart.

In the first embodiment configured as described above, the traffic management device 1 (processor 11) classifies the moving space into three areas including the movable area 31 where the mobile object 2 is movable, the unmovable area 33 where the mobile object 2 is unmovable, and the unclear area 32 where it is unclear whether the mobile object 2 is movable, based on the environment information about the space (moving space) related to the movement plan stored in the storage device 13. The traffic management device 1 creates the first movement plan 34 of the mobile object 2, the first movement plan 34 having the moving path from a departure spot to a destination (first destination) in the moving space, and creates the second movement plan 36 passing through only the movable area 31 as the movement plan of the mobile object 2, the movement plan having a moving path from a departure spot to a destination, when the plan passing through the unclear area 32 is created as the first movement plan. The traffic management device 1 then outputs the first movement plan 34 and the second movement plan 36. In this case, the mobile object 2 is preferably controlled based on the second movement plan 36.

When the first movement plan 34 having an uncertain feasibility at the time of planning is created, the traffic management device 1 configured in this manner creates also the second movement plan 36 having a higher feasibility in addition to the first movement plan. The first movement plan is preferable in view of efficiency if the movement is possible in accordance with this plan at the time of actual movement. If the first movement plan cannot be used, use of the second movement plan having a higher feasibility can be considered. That is, according to the present embodiment, a more preferable movement plan can be selected at the time of actual movement while the feasibility of the arrival at the destination is being ensured.

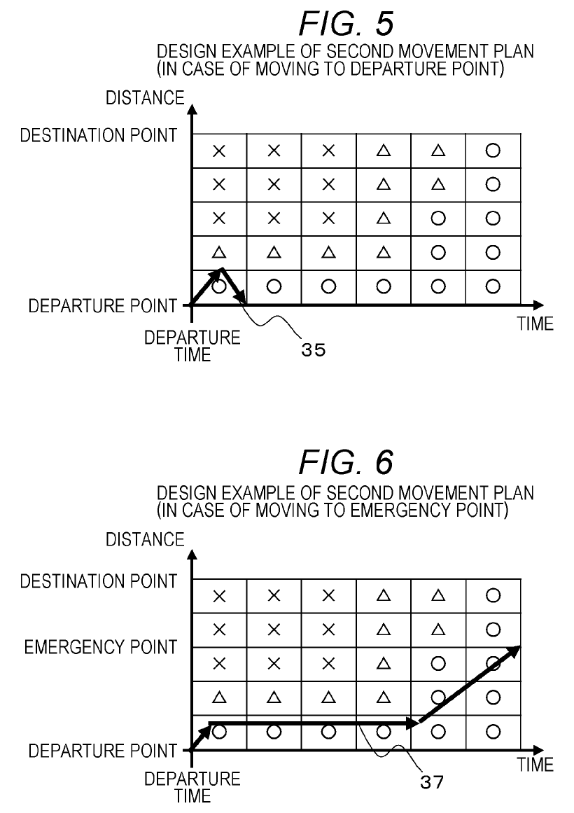

In the above description, the destination of the second movement plan is the same destination (first destination) as the first movement plan 34, but the destination of the second movement plan may be a destination (second destination) different from the first movement plan 34. FIG. 5 is an explanatory diagram in a case where the destination of the second movement plan is a departure spot (second destination). In the second movement plan 35 of this drawing, the mobile object 2 is planned to return to the departure spot after traveling to the boundary of the second divided area without waiting in the first divided area as in the example of FIG. 4.

The destination of the second movement plan may be another place. FIG. 6 is an explanatory diagram in a case where the destination of the second movement plan is an emergency destination. In the second movement plan 37 of this drawing, the destination is neither the first destination nor the departure spot but is the emergency destination (second destination) that is located between the first destination and the departure spot, for example.

As described above, the destination of the second movement plan may be a destination different from that in the first movement plan 34. For example, the emergency destination different from the departure spot and the first destination, or the departure spot may be used as the destination (second destination).

### Second embodiment

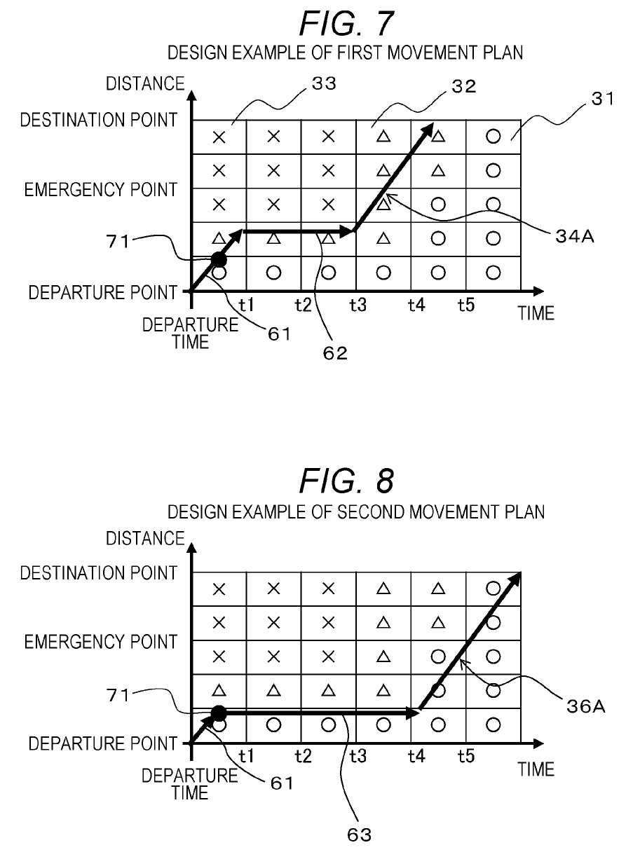

A second embodiment of the present invention will be described below. In the present embodiment, an example of a combination of paths (moving paths) of the first movement plan and the second movement plan will be described with reference to FIGS. 7 and 8.

FIG. 7 illustrates an example of a first movement plan 34A. FIG. 8 illustrates a second movement plan 36A corresponding to the first movement plan 34A of FIG. 7. The first movement plan 34A of FIG. 7 includes a first path 61 from a departure spot to a first relay spot (branch point) 71 in the movable area 31, and a second path 62 from the first relay spot 71 to the first destination via the unclear area 32. The second movement plan 36A in FIG. 8 includes the first path 61 and a third path 63 from the first relay spot 71 to the first destination via only the movable area 31. The first path 61 and the first relay spot 71 are common between the first movement plan 34A and the second movement plan 36A, but the second path 62 and the third path 63 lead to the first destination from the first relay spot 71 using different paths. Note that the second path 62 and the third path 63 may partially overlap. Further, the destination of the second movement plan 36A may be the departure spot or the second destination as in the first embodiment.

When the first movement plan 34A and the second movement plan 36A have the common path to the first relay spot 71 in this manner, the latest environment information can be acquired before the mobile object 2 actually arrives at the first relay spot 71, and the type of the moving space can be reclassified into three areas based on the environment information. As a result, the moving path can be selected based on the classification result of each divided area at a time point close to the time of actual movement of the mobile object 2 (that is, at the time of “classification”), thus increasing the possibility that a more efficient movement plan can be used. Further, for example, even in a case where actual weather is going to be worse, a reliable movement can be achieved based on the second movement plan by creating the second movement plan that passes through only the movable area.

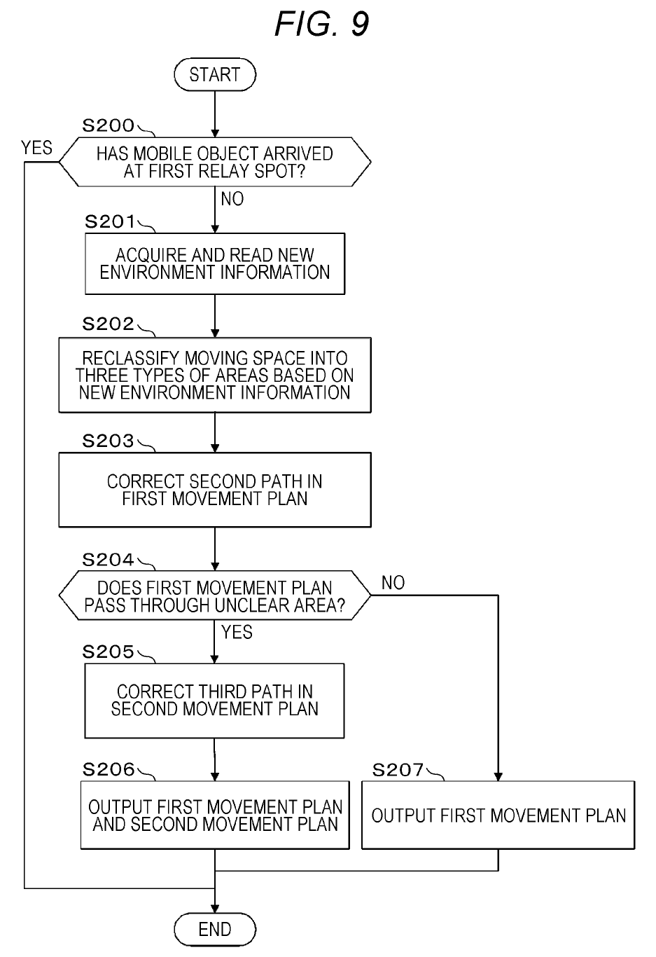

A flowchart of the movement plan creation executed by the processor 11 of the traffic management device 1 according to the present embodiment will be described with reference to FIG. 9. When the flow of FIG. 9 is started, the traffic management device 1 first determines whether the mobile object 2 has arrived at the first relay spot 71 (S200). The current position of the mobile object 2 can be acquired by mounting a GNSS antenna and a receiver (both not illustrated) on the mobile object 2, and the determination related to S200 can be made depending on whether the acquired position of the mobile object 2 has been at the first relay spot 71. When the determination is made that the mobile object 2 has not arrived at the first relay spot 71 in S201, the processing proceeds to S201, and when the determination is made that the mobile object 2 has arrived, the processing ends.

In S201, the traffic management device 1 acquires new environment information, reads the environment information (S201), and reclassifies the moving space into three types of areas including the movable area, the unmovable area, and the unclear area based on the new environment information (S202). Note that the new environment information acquired in S201 may be any environment information after the environment information used when the first movement plan 34A and the second movement plan 36A are created based on the flow of FIG. 2.

The traffic management device 1 corrects the second path 62 in the first movement plan 34A of the mobile object 2 based on the result of reclassifying the moving space into the three types of divided areas in S202 and data of the first relay spot 71 and the destination (destination point) of the mobile object 2 (S203). Note that, if the classification of the divided areas is not changed, the second path 62 and eventually the first movement plan 34A are not changed. Further, regardless of whether the second path 62 is corrected, the first path 61 is assumed to be maintained as it is created in the flow of FIG. 2, and a combination of the first path 61 and the second path acquired in S203 is set as the first movement plan obtained as the result of the processing in S203.

In S204, the traffic management device 1 determines whether the first movement plan obtained in the processing in S203 passes through the unclear area 32. That is, a determination is made whether the second path 62 corrected in S203 passes through the unclear area 32. When the first movement plan (namely, the second path 62) does not pass through the unclear area 32, that is, when the first movement plan passes through only the movable area 31, only the first movement plan is output (S207), and the processing of the flowchart is ended. Examples of the output destination of the first movement plan include the mobile object 2, a terminal installed in a control center, and a terminal of the operator of the mobile object 2 as in the first embodiment.

On the other hand, when the first movement plan (second path 62) acquired as the result of S203 passes through the unclear area 32, the traffic management device 1 corrects the third path 63 in the second movement plan 36A (S105). The third path 63 is formed to pass through only the movable area 31 similarly to the flowchart of FIG. 2. Note that, if the classification of the divided areas is not changed, the third path 63 and eventually the second movement plan 36A are not changed. Further, regardless of whether the third path 63 is corrected, the first path 61 related to the second movement plan is assumed to be maintained as it is created in the flow of FIG. 2, and a combination of the first path 61 and the third path acquired in S205 is set as the second movement plan obtained as the result of the processing in S205.

After creating the second movement plan in S205, the traffic management device 1 outputs the first movement plan and the second movement plan (S206), and ends the processing of the flowchart.

When the traffic management device 1 is operated as described above, the mobile object 2 is operated in accordance with the second movement plan 36A output from the traffic management device 1. Before the mobile object 2 arrives at the first relay spot 71, the processor 11 reclassifies the moving space into the three areas 31,32, and 33 based on the environment information acquired after the creation time of the first movement plan 34A, recreates the second path 62 and the third path 63 based on the classification result, and recreates the first movement plan and the second movement plan based on the recreated second path 62 and third path 63.

That is, by executing the flowchart of FIG. 9, the moving space can be reclassified into three types of areas based on the latest environment information after the first movement plan 34A and the second movement plan 36A are created based on the flow of FIG. 2 until the mobile object 2 actually arrives at the first relay spot 71 (S202). As a result, the second path 62 and the third path 63 can be created (corrected) based on the classification result of each divided area at a time point close to the time of the actual movement of the mobile object 2 (that is, at the time of “classification”), and this makes it possible to increase the possibility that a more efficient movement plan can be used.

Note that the acquisition timing (that is, the execution timing in S201) of the environment information used to reclassify the moving space into the three areas 31,32, and 33 may be set after the creation of the first movement plan 34A and before a predetermined time T1 or more from the scheduled time of arrival of the mobile object 2 at the first relay spot 71 or before the mobile object 2 enters the area within a predetermined distance D1 from the first relay spot 71. In addition, at least one of the predetermined time T1 and the predetermined distance D1 in this case may be input from the outside.

### Third embodiment

A third embodiment of the present invention will be described below.

The present embodiment is characterized in that the third path 63 in the second movement plan includes a stay spot where the mobile object 2 stays in a predetermined area in the movable area 31. The stay spot is a place where the mobile object 2 stays because the unclear area 32 or the unmovable area 33 exists on the moving path. The stay spot is provided in the movable area 31 immediately before the unclear area 32 or the unmovable area 33 on the moving path. In the stay spot, the mobile object 2 stays in the stay spot due to stopping at a fixed point or turning. For example, the stay spot is present also in the second movement plan 36A illustrated in FIG. 8. A straight line portion extending in parallel with the horizontal axis on the second movement plan 36A is the stay spot. The stay spot coincides with a place where the mobile object 2 is located at least between time t1 and time t4, that is, the first relay spot 71. The type of the second divided area from the departure spot is the unclear area 32 until time t4, but is changed to the movable area 31 from time t4 onward. Therefore, a path heading for the destination is created after time t4, and the movement of the mobile object 2 is started from the stay spot (first relay spot) 71 to the destination.

When the stay spot is generated in the third path 63 in this manner, the unclear area 32 and the unmovable area 33 are temporarily generated on the moving path of the mobile object 2. Thereafter, when the area is changed to the movable area 31, the mobile object 2 can arrive at the destination.

Further, in the present embodiment, since the mobile object 2 stays at the stay spot, a battery of the mobile object 2 is likely to be lost before the mobile object 2 arrives at the initial destination (first destination). Therefore, when a movement plan including the stay spot is created as the second movement plan, the traffic management device 1 may determine the destination of the mobile object 2 from the stay spot in consideration of a remaining battery amount of the mobile object 2. For example, the remaining battery amount of the mobile object 2 at the time of departing from the stay spot may be predicted and calculated, and a new destination may be set within a reachable range of the mobile object 2 with the remaining battery amount. As the new destination, another destination (for example, an emergency destination or a second destination) closer to the departure spot than the initial destination (first destination) could be selected, and the departure spot may be selected. The third path 63 in the second movement plan in this case is a path from the relay spot to the new destination via the stay spot.

In this way, when the remaining battery amount of the mobile object 2 is taken into consideration in the determination of the third path including the stay spot, the mobile object 2 can reliably arrive at the destination without depleting the battery of the mobile object 2.

### Fourth embodiment

The present embodiment can also be said to be a modification of the second embodiment, and is characterized in that the traffic management device 1 (processor 11) acquires the environment information about the unclear area 32 on the second path 62 in the first movement plan 34A and updates the environment information stored in the storage device 13 (environment information storage unit 12) in S201 of the flow in FIG. 9. The other points are the same as those of the second embodiment. Note that, hereinafter, the area about which the environment information is updated in the present embodiment may be referred to as an “update target area”.

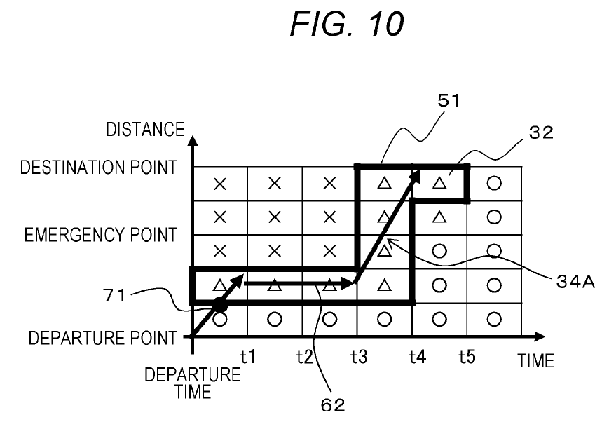

FIG. 10 is an explanatory diagram of an area (update target area) about which new environment information is to be acquired or read in the present embodiment. As illustrated in this drawing, the four divided areas passing through the second path 62 are classified into the unclear area 32 at any time between the departure time to time t5, and the four divided areas are update target areas 51. That is, the traffic management device 1 acquires and reads the environment information about the four divided areas related to the update target areas 51 in S201. When the area about which the environment information is acquired and read is limited in this manner, the communication amount related to the acquisition of the environment information can be reduced, and the time required for correcting the first movement plan 34A and the second movement plan 36A in the flow of FIG. 9 can be shortened.

Note that the environment information acquired in the present embodiment preferably includes weather prediction information acquired from a weather prediction service, but the weather prediction service can be used also in other embodiments.

### Fifth embodiment

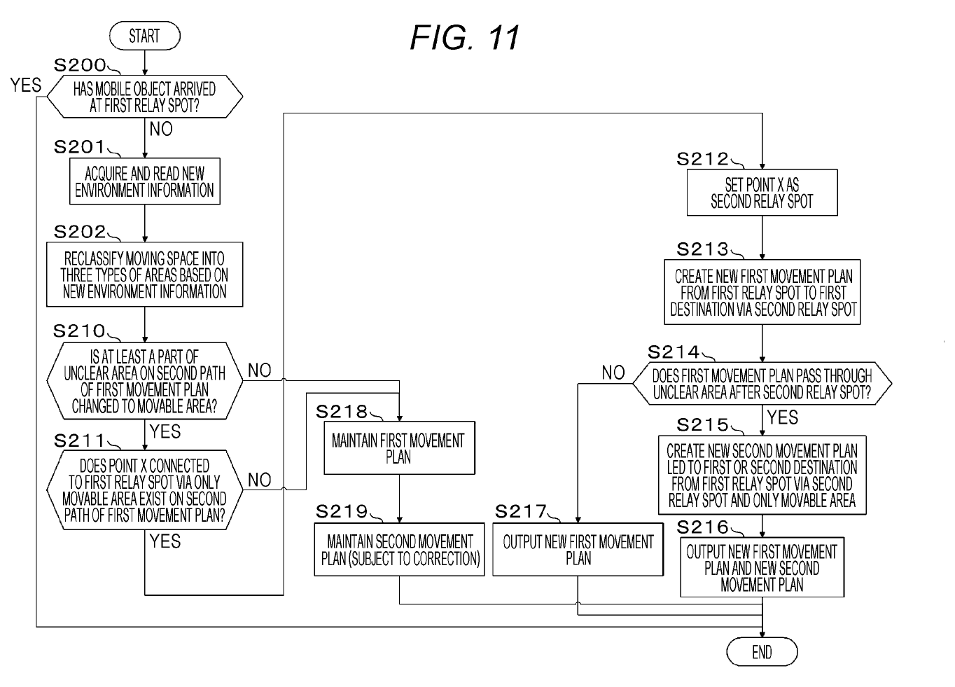

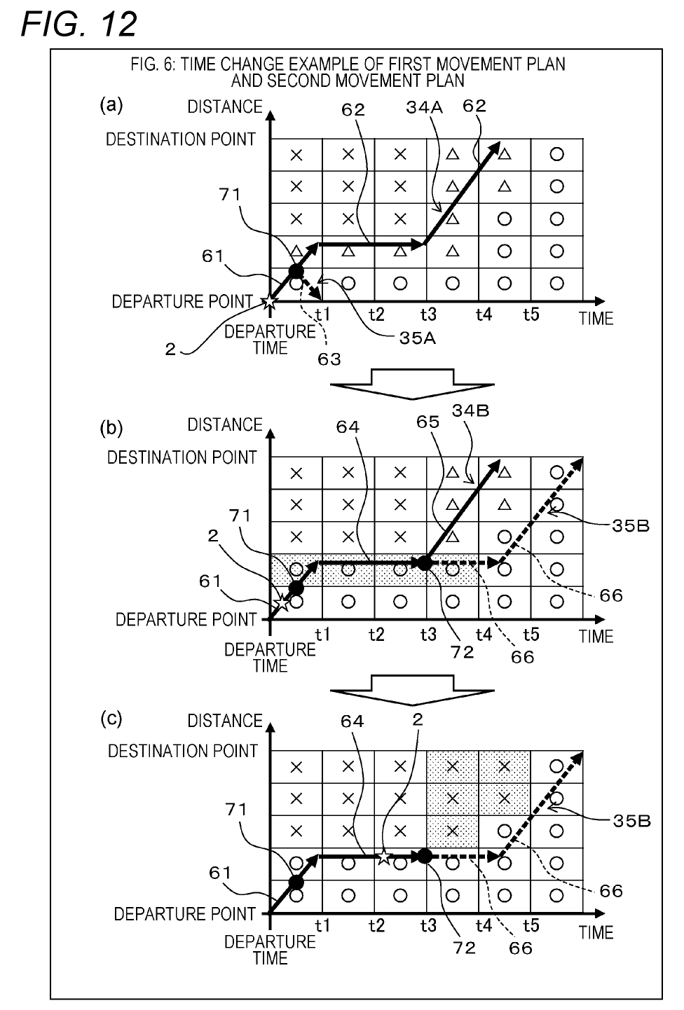

A fifth embodiment of the present invention will be described below. The present embodiment is characterized in that the first movement plan and the second movement plan are corrected using a flow (flow of FIG. 11) obtained by modifying the flow of FIG. 9 according to the second embodiment. More specifically, the present embodiment is characterized in that the second relay spot is added to the first movement plan and the second movement plan after correction.

FIG. 11 is a flowchart of movement plan creation executed by the processor 11 of the traffic management device 1 according to the fifth embodiment. FIG. 12 is an explanatory diagram of changes in the first and second movement plans according to the present embodiment. In the present embodiment, it is assumed that the first movement plan 34A and the second movement plan 35A illustrated in a part (a) located at the top of FIG. 12 are created based on the flow of FIG. 2 before start of the flow in FIG. 11. The second movement plan 35A is the same as the second movement plan 35 of FIG. 5 described above, and has a moving path with the departure spot as the destination. Note that, in FIG. 12, the positions of the mobile object 2 in respective movement plans 34A, 34B, 35A, and 35B are indicated by star signs. In the part (a) of FIG. 12, the mobile object 2 is located at the departure spot. In a part (b) of FIG. 12, the mobile object 2 is located between the departure spot and the first relay spot 71. In a part (c) of FIG. 12, the mobile object 2 is located between the first relay spot 71 and a second relay spot 72.

The flow of FIG. 11 is started until the mobile object 2 arrives at the first relay spot 71 after the first movement plan 34A and the second movement plan 35A illustrated in the part (a) of FIG. 12 are created. Here, it is assumed that the mobile object 2 departs from the departure spot in accordance with the second movement plan 35A and is located in front of the first relay spot 71 as illustrated in the part (b) of FIG. 12. At this time, since the mobile object 2 has not arrived at the first relay spot 71 in S200, the traffic management device 1 acquires new environment information and reads the new environment information into the storage device 13 in S201. The traffic management device 1 reclassifies the moving space (divided areas) into three types of areas including the movable area 31, the unmovable area 33, and the unclear area 32 based on the environment information read in S201, and proceeds to S210.

As a result of classifying the moving space into the three types of divided areas in S202, the traffic management device 1 determines whether the unclear area 32 on the second path 62 in the first movement plan 34A is at least partially changed to the movable area 31 in S210. In the part (b) of FIG. 12, hatching is added to the squares where the type has been changed from the part (a) of FIG. 12, and all the squares are located on the second path 62 in the first movement plan 34A of the part (a) of FIG. 12. All the changed squares are then changed from the unclear area 32 to the movable area 31. Therefore, the determination is made as YES in S210, and the processing proceeds to S211. When the determination is made as NO in S210, the processing proceeds to S218 and the first movement plan 34A is maintained without being changed. In a similar way, the second movement plan 35A is also maintained, and the processing is ended. However, for example, as in S205 of FIG. 9, the second movement plan may be corrected based on the updated classification.

In S211, the traffic management device 1 determines whether a point X connected to the first relay spot 71 via only the movable area 31 has generated on the path in the part (b) of FIG. 12 corresponding to the second path 62 of the first movement plan 34A in the part (a) of FIG. 12. Since a point denoted by reference numeral 72 in the part (b) of FIG. 12 is connected to the first relay spot 71 via only the movable area 31 and corresponds to the point X, a determination is made as YES in S211 and the processing proceeds to S212. If the determination is made as NO in S211, the processing proceeds to S218.

In S212, the traffic management device 1 sets the point X in S211 as the second relay spot 72. In subsequent S213, the traffic management device 1 creates the new first movement plan 34B from the first relay spot 71 to the destination (first destination) via the second relay spot 72. In the example of the part (b) of FIG. 12, the traffic management device 1 creates a path (fourth path 64) from the first relay spot 71 to the second relay spot 72, creates a path (fifth path 65) passing through the unclear area 32 after passing through the path (fourth path 64) to arrive at the destination, and creates the new first movement plan 34B by connecting both the paths (paths 64 and 65).

In S214, the traffic management device 1 determines whether the first movement plan 34B created in S213 passes through the unclear area 32 after passing through the second relay spot 72. In the example of the part (b) of FIG. 12, since the fifth path 65 passes through the unclear area 32 in the first movement plan 34B, the determination is made as YES, and the processing proceeds to S215. If the determination is made as NO in S214, the processing proceeds to S217, and the new first movement plan 34B is output. At this time, the most recently created second movement plan is maintained.

In S215, the traffic management device 1 creates the new second movement plan 35B passing through only the movable area 31 after passing through the first relay spot 71 and the second relay spot 72 and arriving at the destination (first destination or second destination). In the example of the part (b) of FIG. 12, the traffic management device 1 creates a path (sixth path 66) different from the fifth path 65, the path to the destination (first destination or second destination) via only the movable area 31 after passing the fourth path 64, and creates the new second movement plan 35B by connecting the sixth path 66 with the fourth path 64.

In S216, the traffic management device 1 outputs the new first movement plan 34B created in S213 and the new second movement plan 35B created in S215, and ends the processing.

Note that the flow illustrated in FIG. 11 is preferably executed during a period from the departure spot to the next relay spot or during a period from a certain relay spot to the next relay spot.

Here, the movement of the mobile object 2 and changes in the first and second movement plans 34A, 35A, 34B, and 35B will be described with reference to FIG. 12.

First, as illustrated in the part (a) of FIG. 12, the first movement plan 34A and the second movement plan 35A are created before departure of the mobile object 2. Next, as illustrated in the part (b) of FIG. 12, while the mobile object 2 is moving from the departure spot toward the first relay spot 71, the traffic management device 1 acquires environment information (weather prediction information) and reclassifies the moving space into three types of areas based on the environment information. As a result, the classification of the divided areas via which the mobile object 2 is scheduled to pass second has changed from the unclear area 32 to the movable area 31. Based on this result, the first movement plan 34B and the second movement plan 35B are newly created, and the mobile object 2 is moved in accordance with the new second movement plan 35B. Thereafter, as illustrated in the part (c) of FIG. 12, while the mobile object 2 is moving from the first relay spot 71 toward the second relay spot 72, new environment information is acquired, and the moving space is classified into three types based on the new environment information. In the example of the part (c) of FIG. 12, since the unclear area 32 on the fifth path 65 in the first movement plan 34B is changed to the unmovable area 33, the first movement plan 34B cannot be selected, and the mobile object 2 is moved in accordance with the second movement plan 35B as it is. Although the mobile object 2 cannot arrive at the destination in accordance with the second movement plan 35A of the part (a) of FIG. 12 created before the departure, the traffic management device 1 according to the present embodiment creates a movement plan in accordance with a change in environment information after the departure. As a result, the mobile object 2 can arrive at the destination using the second movement plan 35B as illustrated in the example of the part (c) of FIG. 12.

In the above embodiment, before the mobile object 2 moves on the first path 61 in accordance with the second movement plan 35A and arrives at the first relay spot 71, the traffic management device 1 reclassifies the moving space into three types of areas based on the environment information acquired after the creation of the first movement plan 34A. Then, when the unclear area 32 on the second path 62 of the first movement plan 34A is changed to the movable area 31 due to the classification result and the point X on the second path 62 connected to the first relay spot 71 is generated only in the movable area 31, the traffic management device 1 sets the point X as the second relay spot 72. The traffic management device 1 then creates the new first movement plan 34B led to the first destination via the fifth path 65 passing through the unclear area 32 after passing through the fourth path 64 from the first relay spot 71 to the second relay spot 72. The traffic management device 1 creates the new second movement plan 35B led to the first destination or the second destination via the sixth path different from the fifth path in the movable area 31 after passing through the fourth path 64. The traffic management device 1 then outputs the new first movement plan 34B and the new second movement plan 35B.

According to the present embodiment configured as described above, the first movement plan and the second movement plan can be corrected based on the latest environment information acquired before the mobile object 2 arrives at the first relay spot 71. In particular, when the second relay spot 72 is set, newer environment information is acquired between the first relay spot 71 and the second relay spot 72, and the first movement plan 34A and the second movement plan 35B can be further corrected based on the environment information. That is, according to the present embodiment, since the likelihood of being able to create a movement plan based on the latest environment information is increased as compared with the first and second embodiments, a movement plan with higher feasibility and higher efficiency can be selected.

When the relay spots 71 and 72 are set, the moving path until the movement to the relay spots 71 and 72 is common between the first movement plan and the second movement plan. Therefore, the mobile object 2 may be moved in accordance with either the first movement plan or the second movement plan.

### Others

In each of the above embodiments, the type of the moving space (divided area) is classified into three types of areas including the movable area 31, the unmovable area 33, and the unclear area 32 depending on whether the mobile object 2 is movable. Examples of the classification condition include the following. That is, the traffic management device 1 classifies, as the unclear area 32, an area of the moving space about which environment information has not been acquired, and classifies, as the movable area 31, an area of the moving space about which environment information has been acquired and where a determination is made that the mobile object 2 is movable based on the environment information and specification data (in particular, environment resistance data such as a limit altitude, an operating environment temperature, and a maximum wind pressure resistance) of the mobile object 2. The traffic management device 1 classifies, as the unmovable area 33, an area of the moving space about which the environment information has been acquired and where a determination is made that the mobile object 2 is unmovable based on the environment information and the specification data (in particular, environment resistance data such as a limit altitude, an operating environment temperature, and a maximum wind pressure resistance) of the mobile object 2, and classifies, as the unclear area 32, an area of the moving space where the environment information has been acquired and which is incapable of being classified into either the movable area 31 or the unmovable area 33.

Note that the classification condition of the moving space used by the traffic management device 1 may be input from the outside.

The mobile object 2 includes a crewed or uncrewed flying object such as a drone, and may further include any means related to movement and transportation, such as general automobiles such as a private automobile, a bus, a taxi, and a truck, two-wheeled vehicles such as a motorcycle, a bicycle, and a motor-assisted bicycle, a railway, and a mobility scooter.

Incidentally, the present invention is not limited to the above-described embodiments, and includes various modifications within the scope not departing from the gist thereof. For example, the present invention is not limited to one including all the configurations described in the above embodiments, and includes one where a part of the configuration is deleted. Further, a part of the configuration according to a certain embodiment can be added to or replaced with the configuration according to another embodiment.

Each configuration related to the control device (the traffic management device 1 and the mobile object 2), functions, execution processing, and the like of each configuration may be partially or entirely achieved by hardware (for example, logic for executing each function is designed by an integrated circuit). The configuration related to the control device may be a program (software) in which each function related to the configuration of the control device is achieved by being read and executed by an arithmetic processing device (for example, a central processing unit (CPU)). The information related to the program can be stored in, for example, a semiconductor memory (flash memory, solid state disk (SSD), etc.), a magnetic storage device (hard disk drive, etc.), or a recording medium (magnetic disk, optical disk, etc.).

In the description of the above embodiments, control lines and information lines are understood to be necessary for the description of the embodiments. However, not all the control lines and the information lines related to the product are necessarily indicated. In practice, almost all the configurations may be considered to be connected to each other.

What is claimed is:

1. A traffic management device that creates a movement plan of a mobile object, the traffic management device comprising:
a processor; and
a storage device,
wherein the processor
classifies a space into three areas including a movable area where the mobile object is movable, an unmovable area where the mobile object is unmovable, and an unclear area where it is unclear whether the mobile object is movable, based on environment information about the space related to the movement plan stored in the storage device,
creates a first movement plan of the mobile object from a departure spot to a first destination in the space,
creates a second movement plan passing through only the movable area as a movement plan of the mobile object from the departure spot to a second destination different from the first destination or the first destination upon creating a plan passing through the unclear area as the first movement plan, and
outputs the first movement plan and the second movement plan.

2. The traffic management device according to claim 1,
wherein the first movement plan includes a first path from the departure spot to a first relay spot in the movable area and a second path from the first relay spot to the first destination via the unclear area, and
wherein the second movement plan includes the first path and a third path from the first relay spot to the first destination or the second destination via only the movable area.

3. The traffic management device according to claim 2, wherein the second destination is either an emergency destination different from the departure spot and the first destination or the departure spot.

4. The traffic management device according to claim 2,
wherein the mobile object is operated in accordance with the second movement plan output from the traffic management device,
wherein the processor reclassifies, before the mobile object arrives at the first relay spot, the space into the three areas based on environment information acquired after a creation time of the first movement plan, recreates the second path and the third path based on a classification result, and recreates the first movement plan and the second movement plan based on the recreated second path and third path.

5. The traffic management device according to claim 2, wherein the third path in the second movement plan includes a stay spot where the mobile object stays in a predetermined area in the movable area.

6. The traffic management device according to claim 5, wherein the processor calculates, when the third path includes the stay spot, a remaining battery amount of the mobile object at a time point of a departure from the stay spot, sets the second destination within a range reachable with the remaining battery amount, and sets a path from the first relay spot to the second destination via the stay spot as the third path.

7. The traffic management device according to claim 1, wherein the processor acquires environment information about the unclear area on the second path in the first movement plan to update the environment information stored in the storage device.

8. The traffic management device according to claim 7, wherein the environment information includes weather prediction information acquired from a weather prediction service.

9. The traffic management device according to claim 1, wherein the processor
classifies, as the unclear area, an area of the space where the environment information has not been acquired,
classifies, as the movable area, an area of the space where the environment information has been acquired and a determination is made that the mobile object is movable based on the environment information and specification data of the mobile object,
classifies, as the unmovable area, an area of the space where the environment information has been acquired and a determination is made that the mobile object is unmovable based on the environment information and the specification data of the mobile object, and
classifies, as the unclear area, an area of the space where the environment information has been acquired and which is incapable of being classified into either the movable area or the unmovable area.

10. The traffic management device according to claim 1, wherein the processor is able to externally receive classification conditions of the movable area, the unmovable area, and the unclear area.

11. The traffic management device according to claim 4, wherein the processor reclassifies the space into the three areas based on the environment information acquired after the creation of the first movement plan, the environment information being acquired before a predetermined time or more from a scheduled time when the mobile object arrives at the first relay spot or before the mobile object enters an area within a predetermined distance from the first relay spot.

12. The traffic management device according to claim 11, wherein at least one of the predetermined time and the predetermined distance is externally input.

13. A traffic management system comprising the traffic management device according to claim 2,
wherein the processor
reclassifies the space into the three areas based on environment information acquired after creation of the first movement plan before the mobile object moves on the first path in accordance with the second movement plan and arrives at the first relay spot,
sets, when the unclear area on the second path is changed to the movable area by the classification result and a point on the second path connected to the first relay spot is generated only in the movable area, the spot as a second relay spot,
creates a new first movement plan to arrive at the first destination via a fifth path passing through the unclear area after passing through a fourth path from the first relay spot to the second relay spot, and a new second movement plan to arrive at the first destination or the second destination via a sixth path different from the fifth path in the movable area after passing through the fourth path, and
outputs the new first movement plan and the new second movement plan.

14. A traffic management system, comprising:
a mobile object; and
a traffic management device that includes a processor and
a storage device, and creates a movement plan of the mobile object,
wherein the processor
classifies a space into three areas including a movable area where the mobile object is movable, an unmovable area where the mobile object is unmovable, and an unclear area where it is unclear whether the mobile object is movable, based on environment information about the space related to the movement plan stored in the storage device,
creates a first movement plan of the mobile object from a departure spot to a first destination in the space,
creates a second movement plan passing through only the movable area as a movement plan of the mobile object from the departure spot to a second destination different from the first destination or the first destination upon creating a plan passing through the unclear area as the first movement plan, and
outputs the first movement plan and the second movement plan, and
wherein the mobile object is operated in accordance with the second movement plan.
